(19) United States
(12) Patent Application Publication
(10) Pub. No.: US 2018/0118010 A1
(43) Pub. Date: May 3, 2018

(54) Motor Vehicle Cover

(71) Applicant: Covercraft Industries, LLC, Pauls Valley, OK (US)

(72) Inventor: Mark Korros, Lake Oswego, OR (US)

(21) Appl. No.: 15/791,685

(22) Filed: Oct. 24, 2017

Related U.S. Application Data
(60) Provisional application No. 62/414,862, filed on Oct. 31, 2016.

(51) Int. Cl. B60J 11/04

(52) U.S. Cl. CPC B60J 11/04; B60R 25/241

(57) ABSTRACT

A system for protecting a motor vehicle is disclosed. A motor vehicle having an electronic lock openable by a remote radio signal originating from outside the motor vehicle includes a fabric configured to attenuate the transmission of radio waves therethrough. The fabric has a plurality of fibers plated with a metal and formed into a flexible washable, planar material, the fabric. The fabric is shaped to comprise a three-dimensional shape approximating the exterior shape of the motor vehicle and is disposed about the exterior of the motor vehicle substantially enclosing the top and sides of the motor vehicle.

### PRIORITY

This application claims priority to U.S. Provisional Patent Application Ser. No. 62/414,862 entitled “Motor Vehicle Cover” filed on Oct. 31, 2016 which is incorporated herein by reference in its entirety.

### FIELD OF THE INVENTION

This application relates generally to the field of motor vehicle covers and more specifically to protective covers for motor vehicles.

### BACKGROUND

Motor vehicles, such as automobiles, trucks, SUVs, and motorcycles, are typically stored underneath structures to protect them from damage. However, unless the owner of the motor vehicle is near the structure that they use for protecting that motor vehicle, typically other structures are not available. Accordingly, when structures are not available to protect motor vehicles, the motor vehicle is typically left unprotected and subjected to a wide variety of environmental extremes. It is known in the art to provide a protective cover to shield a vehicle from the environment. However, existing motor vehicle cover devices consist of complex, bulky, heavy, and sometimes even useless materials. It also prevents vehicle aficionados from admiring motor vehicles protected by a cover without constantly removing and replacing the cover. The present technology provides a motor vehicle cover that departs from the conventional concepts and designs of motor vehicle covers to provide an apparatus that protects a motor vehicle body from damage and/or theft while, in some instances, allowing third parties to view the exterior of the vehicle.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 is perspective view of a cover in accordance with one embodiment of the invention.

### DESCRIPTION OF THE TECHNOLOGY

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.”

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

Reference in this specification may be made to devices, structures, systems, or methods that provide “improved” performance. It is to be understood that unless otherwise stated, such “improvement” is a measure of a benefit obtained based on a comparison to devices, structures, systems or methods in the prior art. Furthermore, it is to be understood that the degree of improved performance may vary between disclosed embodiments and that no equality or consistency in the amount, degree, or realization of improved performance is to be assumed as universally applicable.

### Example Embodiments

An initial overview of technology embodiments is provided below and specific technology embodiments are then described in further detail. This initial summary is intended to aid readers in understanding the technology more quickly, but is not intended to identify key or essential features of the technology, nor is it intended to limit the scope of the claimed subject matter. Broadly speaking, aspects of the current technology operate to block or attenuate unwanted radio frequencies from intruding into the electronic security system of vehicles and/or providing an improved transparent protective cover. It is intended that the devices of the present technology be operable with different types of motor vehicles so long as the end result of blocking or attenuating unwanted radio frequencies on the one hand and/or providing an improved transparent protective cover on the other hand is achieved.

Bearing that in mind, the motor vehicle cover of the present technology, in accordance with one aspect of the invention, may be broadly described as a transparent material shaped to approximate the three-dimensional volume of a specific motor vehicle. In particular, the transparent material comprises a woven synthetic fiber treated with a polymer. The woven material may be cut into component parts corresponding to different sides of a vehicle and then coupled together to approximate the shape of the vehicle. In another aspect, a single piece of the woven material is folded and seams are placed about portions of the material to create angles wherein the material is shaped to approximate the shape of the vehicle. The end result is a flexible, light-weight, durable motor vehicle cover that is transparent. The cover provides optimal protection to the surface of the vehicle but permits exterior inspection of the vehicle.

In accordance with another aspect of the technology, the invention may be broadly described as a material shaped to approximate the three-dimensional volume of a specific motor vehicle and configured to minimize the transmission of electromagnetic radiation through the material when it is covering a motor vehicle. The material may be cut into component parts corresponding to different sides of a vehicle and then coupled together to approximate the shape of the vehicle. In another aspect, a single piece of the material is folded and seams are placed about portions of the materials to create angles wherein the material is shaped to approximate the shape of the vehicle. The end result is a flexible, light-weight, durable motor vehicle cover that provides optimal protection to the surface of the vehicle and also minimizes the transmission of electromagnetic radiation through the cover and about the vehicle.

In accordance with one aspect of the technology, a hybrid material is disclosed that comprises a woven, transparent material configured to minimize the transmission of electromagnetic radiation through the material while still allowing exterior inspection of the vehicle.

### Improved Transparent Cover Technology

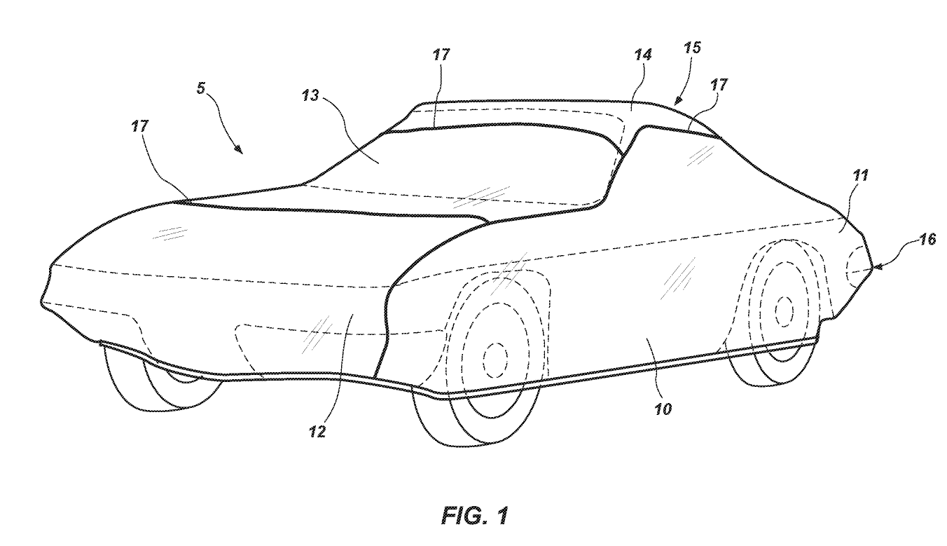

In one aspect, the present technology resides in improved protective covering technology associated with luxury motor vehicles. With reference to FIG. 1, a transparent material 10 is disclosed that is shaped to approximate the three-dimensional volume of a specific motor vehicle make 5. The material is transparent in that once it is placed on top of the vehicle which it was designed to cover, a person may still view the exterior of the motor vehicle through the cover. In one aspect of the technology, the material comprises a substantially transparent synthetic weave including synthetic polymers, such as aliphatic or semi-aromatic polyamides that are melt-processed into fibers, films or shapes, including, but without limitation, nylon. The synthetic weave may also comprise other synthetic fibers as the primary weave and/or components of the weave intended to provide structural support to the material, including, but without limitation, nylon, polyester, acrylic, rayon, acetate, spandex, lastex, orlon, Kevlar, and the like. While synthetic fibers are specifically referenced, it is understood in one aspect that natural fibers (e.g., cotton) or a natural/synthetic blend may also be used.

In one aspect of the technology, the material is woven in what is referred to as a ripstop design. Ripstop fabrics are woven fabrics made using a reinforcing technique to improve resistance to tearing and ripping. During weaving, reinforcement fibers/threads are interwoven at regular intervals in a crosshatch pattern. In one aspect, the reinforcement fibers/threads are thicker than the primary fibers/threads. In an additional aspect, the reinforcement fibers/threads have the same thickness as the primary threads but are made from a different material having, for example, a tensile strength that is greater than the primary material. In one aspect of the technology, the intervals range from 5 to 8 millimeters (or mils). The end result of the ripstop weave is a reinforced woven material. By using a transparent material for the threads in the weave, the material is effectively “see-through” but also resilient and resistant to tearing. In one aspect, the material is not clear, but transparent enough to allow an outside viewer to detect color variations on the surface of the motor vehicle as well as unique shapes and configurations of the motor vehicle.

In one aspect of the technology, each fiber component lying in one direction of a woven fabric is distinguished from the adjacent fiber component in that same direction by interweaving orthogonal fiber components. In a plain weave, for example, the warp and fill fiber components are interwoven wherein the warp fiber components go over and under the fill fiber components, delineating each fill fiber component and distinguishing it from the adjacent fill fiber component. Likewise, adjacent warp fiber components alternate the direction of the interweave with the fill fiber; that is, a first warp fiber component will go over a fill fiber component and a second adjacent warp fiber component will go under that same fill fiber component. This alternate interweaving action is duplicated throughout the fabric creating a weave structure. Therefore, the fill fiber components also delineate each warp fiber component from adjacent warp fiber components. In a twill weave, the warp and fill fiber components are interpreted the same even though there is less actual interweaving of warp and fill fiber components. In a 2×1 twill weave, for example, the offset staggered interweaving structure of that weave means a warp fiber component passes over more than one fill fiber component and lies directly adjacent to another warp fiber component periodically in the fabric. However, the warp and fill fiber components are still delineated by each other even if they are offset or staggered in the fabric, and the fiber components can be clearly identified by inspection.

In one aspect of the technology, the reinforcing fiber component of the fabric is useful in providing tear strength to the fabric and has a tensile strength which is at least 20% greater than the tensile strength of a body or primary fabric fiber component. In one aspect, the reinforcing fiber component contains at least one continuous multi-filamentary fiber. The reinforcing fiber component preferably contains 1 to 3 fibers. If one fiber is used for the reinforcing fiber component, that one fiber may have 10% to 20% greater tensile strength than the tensile strength of a body fabric; if three fibers are used for the reinforcing fiber component, then the combined three fibers may have a tensile strength that is 10% to 20% greater than that of the body fabric component. If more than one fiber is used as the reinforcing fiber component, the fibers may be plied together or may be used without plying. In one aspect of the technology the tensile strength of the fabric ranges from 45 to 55 by 45 to 55 lbf (warp by fill) pursuant to ASTM D 5034. The tongue tear of the fabric ranges from 9.5 to 10.5 by 6.5 to 7.5 lbf (warp by fill) pursuant to ASTM D 5034. The fabric also has a Chatillon Hand measurement ranging from 0.4 to 0.6 lbf (according to ASTM D 4032) and an air permeability ranging from 650 to 750 (according to ASTM D 737 at 125 cubic feet per minute).

In one aspect of the technology, the woven synthetic material comprises a denier rating ranging from between 20 and 80. Denier is a unit of measurement that applies to fiber thickness and in one aspect of the technology, the denier rating of the synthetic material is 30. The woven synthetic material comprises a weight ranging between 0.75 and 1.15 ounces per square yard. In one specific aspect, the woven synthetic material comprises a weight ranging from between 0.9 and 1.1 ounces per square yard. In another aspect the woven synthetic material comprises a weight of 0.96 ounces per square yard. In another aspect of the technology, the woven material 10 comprises a synthetic coating. The coating may comprise polytetrafluoroethylene (PTFE), silicone, or another water-resistance coating. The material 10 may be treated with the coating after it has been woven or before individual threads are woven into the finished fabric product.

In one aspect of the technology, the woven material 10 is to be cut into component parts corresponding to different sides of a vehicle and then coupled together to approximate the shape of the vehicle. That is, in accordance with one aspect of the technology, two first components 11 (one for each side of the vehicle) are cut to approximate the profile of a specific vehicle 5 and a second component 12 is cut to approximate the front and hood of the vehicle. A third component 13 is cut to approximate the windshield of the vehicle. A fourth component 14 is cut to approximate the top of the vehicle. A fifth component 15 is cut to approximate the back window of the vehicle, and a sixth component 16 is cut to approximate the shape of the top of the trunk and back of the vehicle. Each component part is coupled together to form a three-dimensional shape that is similar to the shape of a specific motor vehicle (e.g., a 1974 Dodge Challenger, 1931 Ford Model A, 1962 Chevrolet Corvette, 1966 Morgan 4/4, Lamborghini Gallardo, Ferrari F430, Aston Martin V8 Vantage/Vantage Roadster, etc.). In one aspect, for example, the cover cut for a Ferrari F430 will not fit on a 1962 Chevrolet Corvette because of the differences in the shape of the car. While cars are specifically referenced as possible motor vehicles to be covered by the technology described herein, it is understood that any type of motor vehicle may be covered by the described technology. For example, motorcycles (e.g., Ducati Desmosedici, Ecosse Titanium Series FE Ti XX, etc.) and trucks (e.g., 1963 Jeep Gladiator or 1945 Willys CJ-2A) as well as other motor vehicles are contemplated for use with the covers described herein. Appropriate modifications to the cuts of the fabric are made to accommodate the specific shapes of those vehicles. For example, a cover for a motorcycle is made by cutting two components representing the profile of the motorcycle. A single or multiple components are cut to be placed over different top portions of the motorcycle. Once they are cut, the individual pieces are then coupled together. While specific reference is made herein to motor vehicle covers that are specific to a make and model of a vehicle, it is understood that covers may be constructed to be placed over different models of the same make of the vehicle so long as the shape of the vehicle does not substantially change. For example, an Audi A4 and Audi S4 are different models (A4 vs. S4) of the same make (A4). A motor vehicle cover in accordance with aspects of the technology may be configured to cover both the A4 and S4 models.

In one aspect of the technology, the individual pieces of the woven material 10 are coupled together at seams 17 by sewing, stitching, gluing, bonding, melting, welding, clipping, or other mechanical or chemical means. While up to five cuts of fabric are described above, it is understood that more than five or fewer than five cuts of fabric may be used to create the three-dimensional motor vehicle cover as suits a particular application. For example, in one aspect of the technology, a single piece of fabric is cut to extend from a front end of the motor vehicle (and over the front bumper) to a back end of the motor vehicle (and over the back bumper). Side pieces are then cut and coupled to the single top piece.

In yet another aspect of the technology, a single piece of the woven material is folded and seams 17 are placed about portions of the materials to create angles wherein the material is shaped to approximate the shape of the vehicle. That is, instead of cutting the woven material into different shapes and then coupling them back together in the three-dimensional shape of the specific motor vehicle, a single piece of woven material is folded along edges of the motor vehicle corresponding to, for example, the profile of the motor vehicle. A seam is sewn or otherwise made in the fold to create a permanent angle in the woven material corresponding to the profile. Other folds can be made and sewn into the woven material to create the three-dimensional shape of the specific motor vehicle. A combination of coupling cut pieces together and making seams in pieces of fabric is also contemplated herein. That is, the motor vehicle cover may comprise a plurality of pieces sewn together wherein some of the pieces are folded with seams crated therein to shape the fabric.

### RFID Blocking (Attenuating) Technology

In one aspect, the present technology resides in improved protective covering technology associated with electronically secured motor vehicles. Many vehicles today are locked and unlocked using wireless technology. Some vehicles, for example, have an electronic immobilizer for protecting a vehicle against unauthorized use. In one such device, an inductive key/steering-column lock communication channel constitutes a very short-range radio transmission link operating at around 125 KHz (low frequency) which deactivates the immobilizing function when the electronic key is inserted into the steering-column lock. The ensuing check of a use authorization code stored in the key transponder confirms that the key is the one authorizing the use of the vehicle. The communication is between an RFID (short for “Radio Frequency Identification”) reader mounted in the steering-column lock and the vehicle key with transponder constituting the electronic immobilizer with the additional function of remote control. The transponder device is often packaged in a glass tube or plastic brick for integration in the vehicle key housing. In other less complex devices, vehicles employ an RFID switch powered by received electromagnetic energy from a signal, and may respond only to a signal of its own unique frequency, or to a signal on a common frequency which however has an address code unique to the individual RFID. The RFID will then respond by transmitting a signal to lock or unlock a motor vehicle, open the trunk of the vehicle, or perform some other function associated with the vehicle.

As owners of expensive motor vehicles and/or vehicles containing expensive cargo employ increasingly complex ways of locking vehicles, parties intent on attempting to steal those vehicles and/or their cargo employ increasingly complex means to achieve their objective. It has been reported that parties have devised technology to propagate an RFID signal to motor vehicles that are protected by RFID locking technology that will overcome the aforementioned locking means. Moreover, certain motor vehicles may be equipped with technology that transmits radio waves out of the vehicle. Those radio waves may comprise information that the owner of the vehicle does not want to travel outside of the vehicle when the owner (or user) is not with the vehicle.

The present technology is intended to be operable with numerous cover configurations including both transparent and opaque covers, including any fabric disclosed in this specification. Specific reference is made herein to a particular configuration of a motor vehicle cover intended to minimize unwanted electromagnetic radiation (i.e., radio waves) from passing through the vehicle and unlocking the vehicle's locking mechanism or from passing out of the vehicle, namely a cover that utilizes a fabric configured to block radio frequency signals (“RF”). However, it is understood that any vehicle cover is contemplated for use herein comprising a device for minimizing unwanted radio waves from overcoming vehicle security measures or from minimizing radio waves emanating from within the motor vehicle from escaping beyond the exterior of the “blocking” fabric.

The RF blocking (or attenuating) fabric can be cut and/or sewn as discussed above in connection with the transparent cover and can be made of a variety of different materials. For example, in one aspect of the technology, the RF blocking fabric is weft knitted, plaited, purl stitched, or otherwise joined (including, e.g., a ripstop weave) with a polyester, nylon, or cotton fiber combined with a thin metallic fiber. In one aspect, the fabric comprises 2 to 6 mil silver wire, knitted with 30 Denier nylon having an average hole size of less than 1 mil. The fabric has an attenuation range of 20 to 60 dB from 20 MHz to 4 GHz having a surface conductivity ranging from 0.2 to 1.0 Ohm/square weighing approximately 1.3 ounces per square yard.

Numerous other combinations are contemplated herein. For example, in another aspect, the fabric comprises tin-coated 3 to 5 mil copper wire, knitted with an average hole size of less than 1 mil and is configured to reduce greater than 99 percent of RF signals from 1 MHz to 2.5 GHz having a surface conductivity is 0.1 Ohm/sq. In another aspect of the technology, the fabric comprises a cotton fiber knit with 3 to 5 mil silver fibers having a surface conductivity of about 10 Ohm/sq. By weight, the fabric comprises from 2 to 5 percent silver and from 95 to 98 percent cotton having a weight of 135 g/m². In still another aspect of the technology, the fabric for the cover comprises 3 to 5 mil stainless steel fibers knit with cotton fibers having a resistivity of 300-400 Ohms per square. The fabric attenuates greater than 30 dB ranging from 1 MHz to 2.5 GHz. By weight, the fabric comprises from 20 to 40 percent stainless steel to 60 to 80 percent cotton weighing approximately 180 g/m². In another aspect of the technology, the fabric comprises silver coated copper fibers woven with cotton having a resistivity or 106 Ohm/sq and an attenuation of 38 dB at 1 GHz. By weight, the fabric comprises about 16 to 18 percent copper, 0.5 to 1.5 percent silver, and 80.5 to 83.5 percent cotton weighing approximately 69 g/m². In another aspect of the technology, the fabric is woven from cotton fiber with a 1 to 3 mil silvered and PU-coated spun-in copper thread. The fabric is configured to attenuate 29 dB at 900 MHz. By weight, the fabric comprises 8 to 10 percent copper, 0.2 to 1 percent silver, and 89 to 91.8 percent cotton weighing approximately 115 g/m² with a resistivity of 108 Ohm/sq.

In accordance with one aspect of the technology, the fabric comprises a two-sided fabric. A first side comprises 100 percent cotton, polyester, nylon, or some other common material. A second side comprises knit weave made from silver, copper, nickel, titanium, steel, or any combination thereof. The second side is highly conductive (<1 Ohm/sq), the first side is less conductive (˜100 Ohm/sq). In one aspect, the two-sided fabric attenuates 55 dB from 1 MHz to 2.5 GHz and weighs approximately 164 g/m².

In another aspect of the technology, a transparent RF blocking fabric is used to create the motor vehicle cover. Advantageously, the user can see substantially through the cover but still retain the benefit of blocked RF signals. In one aspect of the technology where the RF blocking fabric is transparent or opaque as suits a particular application, the fabric comprises silver-coated (i.e., silver plated) 3 to 5 mil copper wires spun with cotton (or other non-metallic material, e.g., rayon) yarn, then woven into a washable cotton or polyester material. When woven with polyester, the fabric, by weight, comprises 7 to 8 percent copper, 0.3 to 1 percent silver. The fabric is configured to attenuate 20 dB RF signals at 1 GHz and weighs approximately 65 g/m². In another aspect, a transparent RF blocking fabric comprises a silver coated sheer nylon weave having a shielding effectiveness of greater than 50 dB from 30 MHz to 3 GHz and weighs approximately 40 g/m². The nylon component of this fabric is tribal nylon yarn of Pa6-20Fl denier. In another aspect of the technology, the fabric comprises a nickel and copper coated polyester mesh. This fabric is configured to attenuate greater than 50 dB from 10 MHz-3 GHz and weighs 45 g/m². The fabric, by weight, comprises 20 to 25 percent copper, and 8 to 12 percent nickel. In yet another aspect of the technology, the transparent RF blocking fabric comprises a woven 132/inch mesh polyester fiber (0.0068 inch openings) coated with zinc-blackened nickel over copper. The fabric is configured to have an attenuation rating of greater than 40 dB from 10 MHz to greater than 1 GHz.

In one aspect of the technology the textile or fabric is plated with a metal. However, in one aspect, only one side of the textile or fabric is electro or electrolessly plated with a metal, such as silver. In an aspect, the first side has between about 8 percent by weight silver and 35 percent by weight silver. Alternatively, the first side has between about 15 and 25 percent by weight silver, or alternatively between about 18 and 22 percent silver. The foregoing ranges, however, can also comprise the percentage weight of silver plated on the entire fiber wherein the fiber has a weight ranging from 1.5 to 1.65 ounces per square yard, and resistivity (before washing) ranging from 0.35 to 0.45 Ohm/sq. Likewise, the fabric has an air permeability of between 20 and 30 cfm according to ASTM D 737.

In one aspect of the technology, the fabric can be washed in accordance with wash procedure AATCC test method 130-1981 for a plurality of washings and there is no measurable change in the surface of the silver coating. Such a test method merely provides a standard which, upon numerous washes in accordance with such, the treated fabric will not lose an appreciable amount of its RF blocking metal treatment. In an aspect, such wash durability will be maintained after 3 washes, after 5 washes, and alternatively 10 washes, all in accordance with the AATCC Test Method noted above.

Any combinations of polyamides, such as nylon 6 and nylon 6.6, can be used with other fibers to make up the fabric. Natural or synthetic fiber may be utilized as the base for coating the fabric with silver. Thus, natural (cotton, wool, and the like) or synthetic fibers (polyester, polyolefin, spandex and the like) may constitute part of the material used to make the fabric, either by itself or in any combinations or mixtures. Synthetics, naturals, or blends or combinations thereof can be used. One aspect of the technology uses at least 5% polyamides, such as nylon 6 and nylon 6.6, as the silver coated fiber. As for the other yarn types, for instance, and without intending any limitations therein, polyolefins, such as polyethylene, polypropylene, and polybutylene, halogenated polymers, such as polyvinyl chloride, polyesters, such as polyethylene terephthalate, polyester/polyethers, polyurethane, as well as spandex/elastane (block copolymer of polyurethane and polyethylene glycol) homopolymers, copolymers, or terpolymers in any combination of such monomers, and the like, may be utilized within this invention. In one embodiment polyethylene terephthalate (a polyester) can be used as the other fiber.

Additionally, the fabric may be coated with any number of different films. The technology allows any non-silver coated fibers in the fabric to be dyed or colored to provide other aesthetic features for the end user with any type of colorant, such as, for example, poly(oxyalkylenated) colorants, as well as pigments, dyes, tints, and the like. Other additives may also be present on and/or within the fabric or yarn, including antistatic agents, brightening compounds, nucleating agents, antioxidants, UV stabilizers, fillers, permanent press finishes, softeners, lubricants, curing accelerators, and the like. Other optional and supplemental finishes to the inventive fabrics can be employed such as soil release agents, which improve the wettability and washability of the fabric. Other finishes such as soil release agents may be employed and include those which provide hydrophilicity of the surface of polyester. With such a modified surface, again, the fabric imparts improved comfort to a wearer by wicking moisture. Additionally, other potential additives and/or finishes may include water repellent fluorocarbons and their derivatives.

In one aspect of the technology, treatment comprises at least 2%, alternatively 3%, or alternatively 5% of polyamide material such as nylon 6 or nylon 6.6 so that this component of the fabric can be electrolessly plated with metal. It is contemplated that other metals may also be suitable for their desired characteristics. The term silver particle is intended to encompass any compound which comprises of silver in its elemental or ionic state (thus Ag° or Ag+ may be present). Metal salts may also be present in some amount either in a pure state, or reduced to produce the desired metal particles.

The fabric can be a combination of a polyamide yarn such as nylon 6 or nylon 6.6 and other fibers, or a fabric comprising individual fibers or yarns (with the ability of the polyamide fibers to be electrolessly silver plated). Any non-polyamide individual fibers or yarns may be of any typical source for utilization within fabrics, including natural fibers (cotton, wool, ramie, hemp, linen, and the like), synthetic fibers (polyolefins, polyesters, polyaramids, acetates, rayon, acrylics, spandex/elastane and the like), and inorganic fibers (fiberglass, boron fibers, and the like). The target yarn may be of any denier, may be of multi- or mono-filament, may be false-twisted or twisted, or may incorporate multiple denier fibers or filaments into one single yarn through twisting, melting, spun and the like. The fabrics may be produced of the same types of yarns discussed above, including any blends thereof. Such fabrics may be of any standard construction, including knit, woven, or non-woven forms.

In one aspect of the technology, the motor vehicle cover may comprise one or more different fabrics described in this disclosure. In this manner, if a security component (i.e., RFID receiver) within a motor vehicle is located in a particular area of the motor vehicle, the fabric of the motor vehicle cover corresponding to that area of the motor vehicle may be made of an RFID blocking material and the remainder of the motor vehicle cover may be made of a less expensive material.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

1. A system for protecting a motor vehicle, comprising:
a motor vehicle having an identified make and an electronic lock openable by a remote radio signal originating from outside the motor vehicle;
a fabric configured to attenuate the transmission of radio waves therethrough, the fabric comprising a plurality of fibers plated with a metal and formed into a flexible washable, planar material, the fabric having a finished weight ranging from 1.55 to 1.65 ounces per square yard;
wherein the fabric is shaped to comprise a three-dimensional shape approximating the exterior shape of the motor vehicle make and is disposed about the exterior of the motor vehicle substantially enclosing the top and sides of the motor vehicle.

2. The system of claim 1, wherein the metal comprises copper, nickel, tin, silver or any combination of these.

3. The system of claim 1, wherein the fiber comprises nylon, polyester, rayon, cotton, or any combination of these.

4. The system of claim 1, wherein the fabric comprises a tensile strength of 50 by 50 lbf and a tongue tear of 10 by 7 lbf.

5. The system of claim 1, wherein the fabric comprises a resistivity ranging from 0.35 to 0.45 Ohm/sq.

6. The system of claim 1, wherein the fabric comprises an air permeability ranging from 20 to 30 cfm.

7. The system of claim 1, wherein the fabric comprises between 8 and 10 percent by weight silver, between 15 and 25 percent by weight silver, or between about 18 and 22 percent silver.

8. The system of claim 1, wherein the motor vehicle has a make and model and wherein the fabric is shaped to comprise a three-dimensional shape approximating the exterior shape of the make and model of the vehicle.

9. The system of claim 1, wherein the fabric is electrolessly plated with the metal.

10. A system for protecting a motor vehicle, comprising:
a motor vehicle having an identified make and an electronic lock openable by a remote radio signal originating from outside the motor vehicle;
a fabric configured to attenuate the transmission of radio waves therethrough, the fabric comprising a first metal fiber woven with a non-metal fiber formed into a flexible washable, planar material, the fabric having a finished weight greater than 1.6 ounces per square yard;
wherein the fabric is formed to comprise a three-dimensional shape approximating the exterior shape of the motor vehicle make and is disposed about the exterior of the motor vehicle substantially enclosing the top and sides of the motor vehicle.

11. The system of claim 10, wherein the first fiber comprises copper, nickel, tin, silver or any combination of these.

12. The system of claim 10, wherein the second fiber comprises nylon, polyester, rayon, cotton, or any combination of these.

13. A method for protecting a motor vehicle, comprising:
placing a fabric over the motor vehicle, wherein the motor vehicle has an electronic lock openable by a remote radio signal originating from outside the motor vehicle, and wherein the fabric comprises a plurality of fibers plated with a metal and formed into a planar material, the fabric having a finished weight ranging from 1.5 to 1.7 ounces per square yard, and wherein the fabric is shaped to comprise a three-dimensional shape approximating the exterior shape of the motor vehicle and is disposed about the exterior of the motor vehicle substantially enclosing the top and sides of the motor vehicle; and
attenuating radio signals emanating from an exterior surface of the fabric that are propagated in a direction of the motor vehicle located within the interior of the fabric.

14. The method of claim 13, wherein the fabric comprises nylon, polyester, acrylic, rayon, acetate, spandex, lastex, orlon, or Kevlar.

15. The method of claim 13, wherein the fabric is coated with a water-proofing material.

16. The method of claim 13, wherein the metal comprises copper, nickel, tin, silver or any combination of these.

17. The method of claim 13, wherein the fabric comprises a washable, ripstop woven nylon fabric formed into a three-dimensional shape configured to approximate the exterior shape of the motor vehicle.

18. The method of claim 13, further comprising the step of attenuating signals emanating from the motor vehicle propagated outward from the motor vehicle in the direction of the fabric.

19. The method of claim 13, wherein the fabric comprises between 8 and 10 percent by weight silver, between 15 and 25 percent by weight silver, or between about 18 and 22 percent silver.

20. The method of claim 13, further comprising the step of permitting signals emanating from the motor vehicle propagated outward from the motor vehicle to pass through the fabric.
